(19) United States
(12) Patent Application Publication
(10) Pub. No.: US 2024/0375019 A1
(43) Pub. Date: Nov. 14, 2024

(54) GENERATING AND SHARING A GAMEPLAY INFORMATION RESOURCE

(71) Applicant: Sony Interactive Entertainment Inc., Tokyo (JP)

(72) Inventors: Maurizio Cerrato, London (GB); Christopher William Henderson, London (GB); Jun Yen Leung, London (GB); Paul Terence Mulligan, London (GB)

(73) Assignee: Sony Interactive Entertainment Inc., Tokyo (JP)

(21) Appl. No.: 18/650,325

(22) Filed: Apr. 30, 2024

(30) Foreign Application Priority Data
May 11, 2023 (GB) 2306945.3

(51) Int. Cl. A63F 13/87; A63F 13/537; A63F 13/79

(52) U.S. Cl. CPC A63F 13/87; A63F 13/537; A63F 13/79

(57) ABSTRACT

Apparatus includes communication circuitry and processing circuitry. The communication circuitry to receive a progress indicator indicative of a player's progress in a game, and to receive gameplay information comprising supplementary information related to content of the game. The processing circuitry to generate, based on the player progress indicator and the received gameplay information, a gameplay information resource associated with the player. The communication circuitry is configured to receive, from a device, a player identifier identifying the player, and is responsive to receiving the player identifier to make the generated gameplay information resource accessible to the device.

### BACKGROUND

The present technique relates to the field of information processing.

Videogame players can consult supplementary information about a game to learn more about the game, including game lore (e.g. information about individual characters, locations or storylines in the game) and advice on how to play the game. An example of such supplementary information could be a game “wiki”—for example, a wiki may be a website or database developed collaboratively by a community of users, allowing any user to add and/or edit content.

It would be advantageous to improve the experience of consulting supplementary gameplay information.

In a first example of the present technique, there is provided an apparatus of claim 1.

In another example of the present technique, there is provided a method of claim 11.

In another example of the present technique, there is provided an apparatus of claim 12.

In another example of the present technique, there is provided a computer program of claim 14.

Further respective aspects and features of the invention are defined in the appended claims.

### BRIEF DESCRIPTION OF THE DRAWING

Embodiments of the present invention will now be described by way of example with reference to the accompanying drawings, in which:

FIG. 1 illustrates an example of an entertainment system;

FIG. 2 illustrates an apparatus for generating a gameplay information resource;

FIGS. 3A and 3B illustrate examples of arrangements comprising an apparatus for generating a gameplay information resource and an entertainment device;

FIGS. 4A and 4B illustrate examples of arrangements comprising an apparatus for generating a gameplay information resource and gameplay information storage circuitry;

FIG. 5 illustrates an apparatus for generating a gameplay information resource;

FIG. 6 illustrates interactions between an apparatus for generating a gameplay information resource and multiple player devices;

FIG. 7 is a flow diagram illustrating an example method of generating a gameplay information resource;

FIG. 8 is a flow diagram illustrating another example method of generating a gameplay information resource;

FIG. 9 is a flow diagram illustrating another example method of generating a gameplay information resource; and

FIG. 10 is a flow diagram illustrating an example method of selecting information for inclusion in a gameplay information resource.

For clarity of illustration, elements illustrated in the figures have not necessarily been drawn to scale. Further, where considered appropriate, reference numerals have been repeated among the figures to indicate corresponding or analogous elements.

### DETAILED DESCRIPTION

Methods and systems are disclosed. In the following description, a number of specific details are presented in order to provide a thorough understanding of the embodiments of the present invention. It will be apparent, however, to a person skilled in the art that these specific details need not be employed to practice the present invention. Conversely, specific details known to the person skilled in the art are omitted for the purposes of clarity where appropriate.

In the present application, the words “comprising at least one of . . . ” are used to mean that any one of the following options or any combination of the following options is included. For example, “at least one of: A; B and C” is intended to mean A or B or C or any combination of A, B and C (e.g. A and B or A and C or B and C).

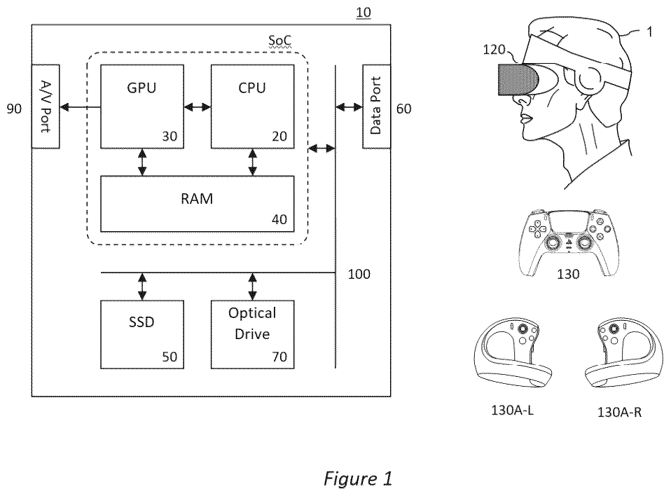

Referring to FIG. 1, an example of an entertainment system 10 is a computer or console such as the Sony® PlayStation 5® (PS5).

The entertainment system 10 comprises a central processor 20. This may be a single or multi core processor, for example comprising eight cores as in the PS5. The entertainment system also comprises a graphical processing unit or GPU 30. The GPU can be physically separate to the CPU, or integrated with the CPU as a system on a chip (SoC) as in the PS5.

The entertainment device also comprises RAM 40, and may either have separate RAM for each of the CPU and GPU, or shared RAM as in the PS5. The or each RAM can be physically separate, or integrated as part of an SoC as in the PS5. Further storage is provided by a disk 50, either as an external or internal hard drive, or as an external solid state drive, or an internal solid state drive as in the PS5.

The entertainment device may transmit or receive data via one or more data ports 60, such as a USB port, Ethernet® port, Wi-Fi® port, Bluetooth® port or similar, as appropriate. It may also optionally receive data via an optical drive 70.

Audio/visual outputs from the entertainment device are typically provided through one or more A/V ports 90, or through one or more of the wired or wireless data ports 60.

An example of a device for displaying images output by the entertainment system is a head mounted display ‘HMD’ 120, such as the PlayStation VR 2 ‘PSVR2’, worn by a user 1.

Where components are not integrated, they may be connected as appropriate either by a dedicated data link or via a bus 100.

Interaction with the system is typically provided using one or more handheld controllers (130, 130A), such as the DualSense® controller (130) in the case of the PS5, and/or one or more VR controllers (130A-L, R) in the case of the HMD.

A player of a videogame may seek to learn more about elements of the game, for example information relating to game lore (such as information about in-game characters, locations or storylines, advice/hints for playing the game, and so on). Hence, the player may consult supplementary information (e.g. information other than the game data of the game itself) about the game. An example of such supplementary information could be a wiki that is dedicated to a particular game—for example, a wiki may be a community-managed online resource providing information about the game. For example, the supplementary information could comprise at least one of: text describing one or more in-game elements (e.g. game wiki may include webpages displaying text describing game elements); video data describing one or more in-game elements; and audio data describing one or more in-game elements.

Note that the supplementary information can include information that can be learned/obtained through playing the game, but may also (or instead) comprise information that cannot be directly obtained through playing the game (e.g. background information provided by the game developers, fan-generated content (e.g. fan-fiction, fan theories, etc.), and/or advice or tutorials on how to successfully play the game).

As a particular example, the one or more in-game elements described by the supplementary information could include any of: one or more in-game characters (e.g. non-player characters, NPCs, which may be encountered by the player); one or more in-game locations (e.g. locations in the game which can be visited by the player); one or more in-game storylines; in-game lore; and one or more in-game user controls (e.g. information about how to play the game).

However, consulting supplementary information about a game could lead to the player inadvertently coming across spoilers for the game (e.g. a player may look up an unassuming side character that ends up being the game's villain) and/or being able to cheat by obtaining information that the game has not yet presented to them (e.g. the player may look up the weaknesses of a particular enemy or advice/tutorials about how to defeat a particular enemy, or see areas of a map not yet revealed to them).

The present technique provides an improved approach to accessing supplementary information about a game. In particular, the present technique provides mechanisms for adjusting (e.g. on a per-player basis) the amount of information displayed to a given user of the supplementary information, based on how far the user has progressed within the particular game. This is advantageous as it can prevent spoilers being accidentally shown to the user, and may also help to prevent cheating. This is achieved by way of a user ID which the user uses to log-in to a wiki app (optionally automatically if referred to the wiki app by the game or a helper app on the entertainment device). The wiki app can then, based on the provided user ID, amends wikis that are dedicated to games that the user is playing (and optionally, those which the user hasn't played).

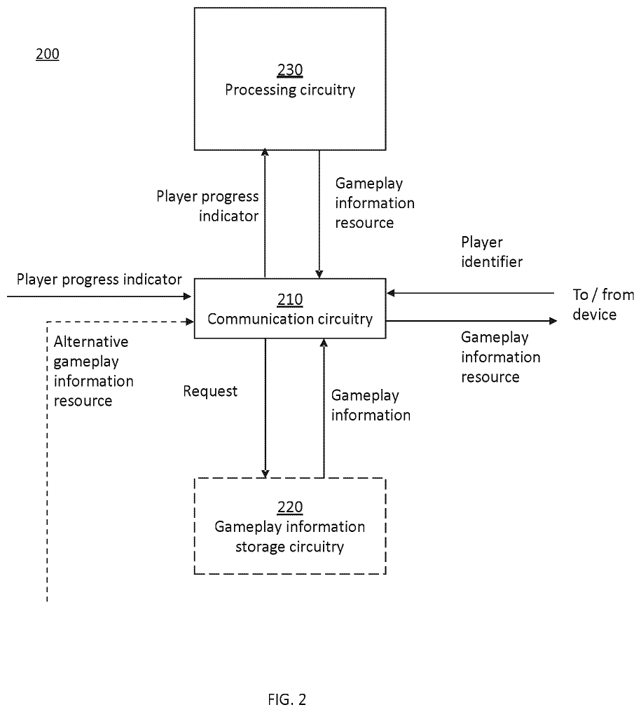

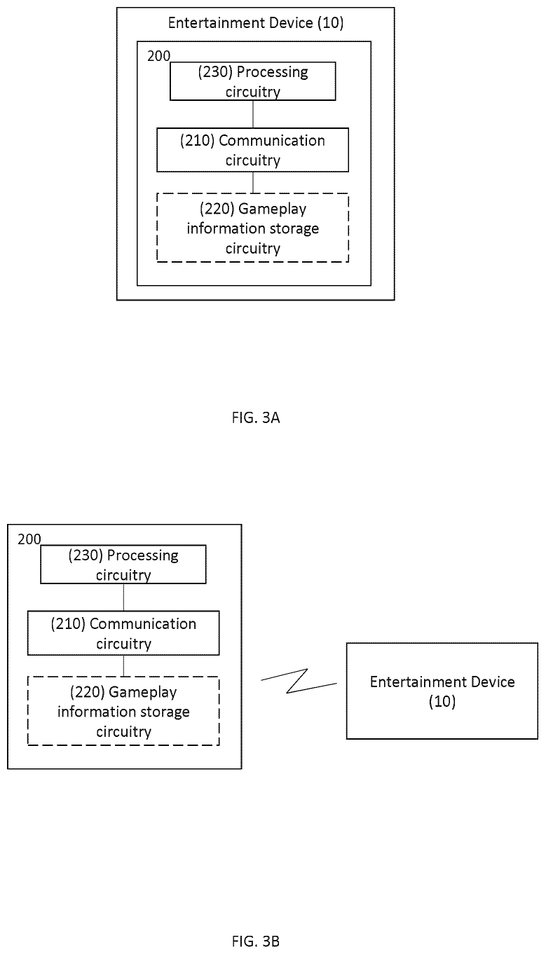

For example, the present technique provides an apparatus comprising communication circuitry and processing circuitry. An example of such an apparatus 200 is shown in FIG. 2. The apparatus 200 could be part of the entertainment device 10 described above (see, for example, FIG. 3A), or it could be a separate entity (see, for example, FIG. 3B—for example, the apparatus 200 could be part of a server accessible to one or more entertainment devices and/or other personal communication devices such as mobile phones, computers, etc.)

As shown in FIG. 2, the apparatus 200 comprises communication circuitry 210, which is configured to receive a progress indicator indicative of a player's progress in a game, and to receive gameplay information comprising supplementary information related to content of the game. The player progress indicator could, for example, be received from an entertainment device on which the player is playing the game, and could indicate one or more of: a player's level in the game (e.g. the game may define a number of levels, and the player may climb through the levels as they progress through the game); in-game advancements unlocked by the player; in-game skills unlocked by the player; in-game items gathered by the player; in-game locations visited by the player; in-game characters encountered by the player; in-game plot points unlocked by the player; and an amount of time spent playing the game.

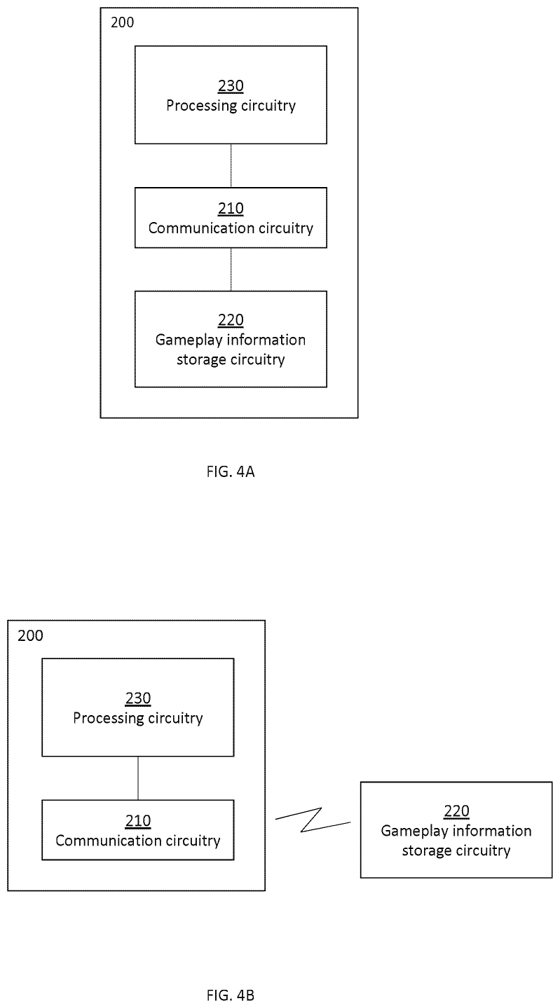

The gameplay information is obtained from gameplay information storage circuitry 220, which may be part of (see FIG. 4A, for example) or separate from (see FIG. 4B, for example) the apparatus 200. For example, the gameplay information could be information obtained (e.g. downloaded—for example, the communication circuitry may be able to download the information over the Internet) from an external server. The gameplay information storage circuitry may, therefore, be part of the external server, or—e.g. if the gameplay information is obtained in advance and stored locally on the apparatus 200—it could be part of the apparatus 200.

The gameplay information may be received by the communication circuitry 210 in response to the communication circuitry sending, to the gameplay information storage circuitry, a request for the gameplay information. For example, the communication circuitry 210 may be configured to send the request to the gameplay information storage circuitry 220 in response to receiving at least one of: a gameplay information resource request (e.g. a request to generate a gameplay information resource for particular player—this could be sent by an entertainment device 10 or a personal device associated with the player (such as a mobile telephone, personal computer, etc.)); the player progress indication (e.g. the player progress indication may also function as an implicit gameplay information resource request); and an indication that the game has been added to the player's game library (e.g. when the player obtains (e.g. buys and/or downloads) a new game, an indication of this may be sent to the apparatus as an implicit gameplay information resource request).

The apparatus 200 also includes processing circuitry 230, configured to generate, based on the player progress indicator and the received gameplay information, a gameplay information resource associated with the player.

The gameplay information resource may be a version of the gameplay information that is personalised to the individual player—for example, some parts of the gameplay information may be included in the gameplay information resource while other parts (e.g. parts relating to game elements that have not yet been encountered by the player) may be excluded. The player progress indicator is used to decide which parts to include and which parts to exclude. Other factors (e.g. information provided by the player) could also be taken into account. Hence, the gameplay information resource comprises a subset of the gameplay information stored by the gameplay information storage circuitry, wherein the subset is selected in dependence on the player progress indicator.

Note that the gameplay information received from the gameplay information storage may itself be a subset of the stored gameplay information (e.g. the communication circuitry may request a specific subset of the information based on the player progress indicator), or the communication circuitry may receive all of the gameplay information (e.g. all of the information on a wiki for a particular game), and the processing circuitry may extract parts of the information to include in the gameplay information resource.

The gameplay information may be updated at times (e.g. following an update to the game or the creation of additional information by a wiki author), and this may also be taken into account when generating the gameplay information resource.

The gameplay information resource may be generated either by accessing information resources that are commensurate with the user's progress or state (i.e. a positive generation of appropriate content) or by blocking information resources that are not commensurate with the player's progress or state (i.e. a negative generation of appropriate content). Hence information resources may in effect be whitelisted and/or blacklisted for different progress/states of the user. Notably if content is created without being associated with user progress or state (as may be the case in a public wiki, where not everyone may fully adhere to publication rules), then a whitelisting approach may ensure no spoilers (since the new content has not been whitelisted), whilst a blacklisting approach may ensure maximum available content (since the new content has not been black listed). Optionally, the system may use whitelisting for some content and blacklisting for other content; for example whitelisting for locations, quests, etc., not yet visited, and blacklisting for areas or quests already completed (or completed to a threshold degree).

The communication circuitry 210 is also configured to receive, from a device (e.g. a personal communication device, such as a mobile telephone or a personal computer, or an entertainment device 10), a player identifier identifying the player. For example, this could be login credentials (e.g. a username and password) for the player. For example, these details could be received over the Internet. The communication circuitry 210 is then responsive to receiving the player identifier to make the generated gameplay information resource accessible to the device. Hence, a player can access a personalised version of supplementary gameplay information.

A first user may wish to know more about the game, but may not want to play the game. Alternatively, the first user may wish to be conversant with another player who has progressed further through the game, and hence may want to access a version of the supplementary information that takes into account the progress made by both players. Hence, it can be useful if one user can request that a second user shares their version of the supplementary information with the first user (which may, for example, have more information displayed thereon than that of the first user). The act of sharing the second user's version of the supplementary information could, for example, be used to “fill-in” the first user's version of the supplementary information so that it matches that of the second user's, optionally with an warning/invite to proceed when the fill-in supplementary information is about to be shown. This also allows a friend to be conversant with a user as they progress without accidentally giving away spoilers.

Therefore, FIG. 2 also shows that the communication circuitry 210 can receive an alternative gameplay information resource (e.g. a gameplay information resource associated with a further player). The alternative gameplay information resource may, for example, be received from another apparatus similar to the apparatus 200 shown in FIG. 1; alternatively, the alternative gameplay information resource may be received from internal storage (e.g. gameplay information storage circuitry 220) on the same apparatus 200; alternatively, the alternative gameplay information resource may be generated in the same way as the supplementary information for the first user, but using the status information of the second user to generate a parallel set of supplementary information that acts as the alternative gameplay information resource. Then, the processing circuitry 230 is configured to generate the player's own gameplay information resource in dependence on the additional gameplay information resource.

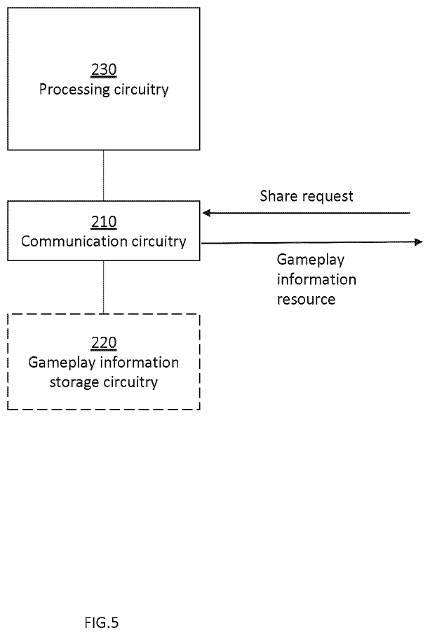

In addition, FIG. 5 shows the communication circuitry 210 receiving a share request associated with the player identifier, the share request comprising a further player identifier identifying a further player. The communication circuitry 210 is responsive to receiving the share request to make the generated gameplay information resource accessible to a further device associated with the further player identifier. The further player can then view the gameplay information resource created for the original player, or the gameplay information resource can be used to supplement the further player's own gameplay information resource.

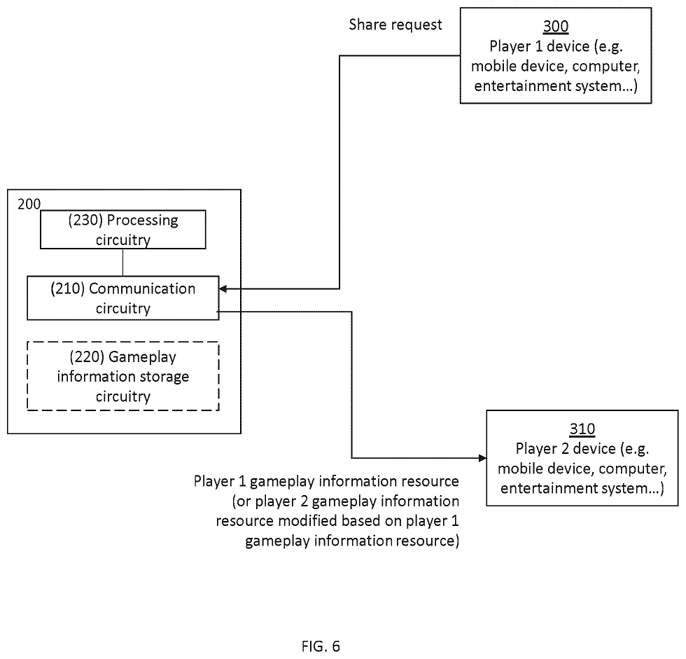

A possible exchange of requests and responses is illustrated in FIG. 6. For example, FIG. 6 shows a first player's (Player 1) device 300 sending a share request. The share request is associated with (by virtue of being sent by) the first player, and also identifies a second player (Player 2). The communication circuitry 210 of the apparatus 200 then responds to the share request (optionally after authenticating—e.g. by requesting and authenticating login information of-one or both of the players) by sending (or making available), to a device 310 controlled by the second player, a copy of Player 1's gameplay information resource (or, alternatively, a copy of Player 2's gameplay information resource, modified based on Player 1's gameplay information resource).

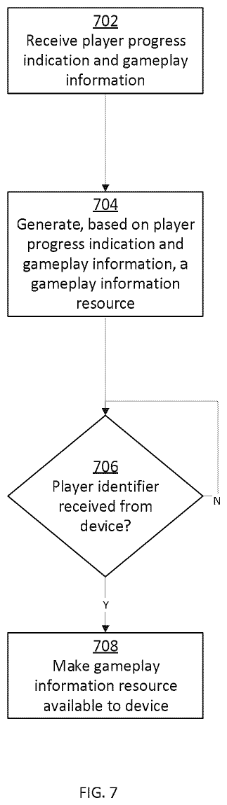

FIG. 7 shows an example method for providing a gameplay information resource. The method comprises steps of: 702: receiving a progress (or equivalently, state) indicator indicative of a player's progress (or state) in a game, and receiving gameplay information comprising supplementary information related to content of the game; 704: generating, based on the player progress indicator and the received gameplay information, a gameplay information resource associated with the player; 706: receiving, from a device, a player identifier identifying the player; 708: in response to receiving the player identifier, making the generated gameplay information resource accessible to the device.

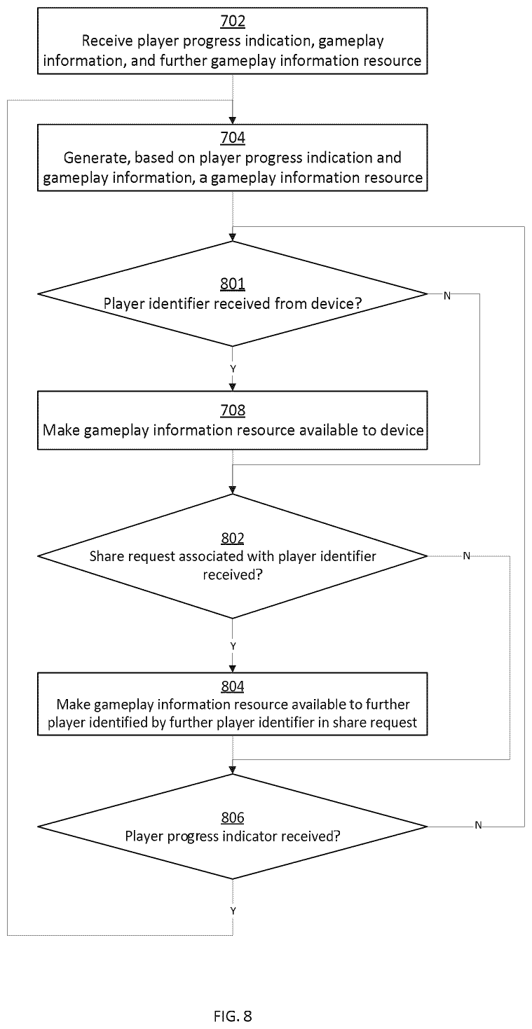

FIG. 8 shows an example method for generating and sharing a gameplay information resource. In addition to steps 702, 704 and 708 of FIG. 7, this method includes: 801: in place of step 702, a step 801 is provided which involves determining whether a player identifier has been received. If a player identifier is received from a device, the method proceeds to step 708 as in FIG. 7. However, if a player identifier is not received from a device, the method instead proceeds to step 802 (discussed below); 802: a share request is received, the share request being associated with the player identifier, the share request comprising a further player identifier identifying a further player; 804: in response to receiving the share request, the generated gameplay information resource is made accessible to a further device associated with the further player identifier; 806: the method may then comprise determining whether an updated player progress indicator has been received, and re-generating 704 the gameplay information resource if so. Otherwise, the method may return to step 801.

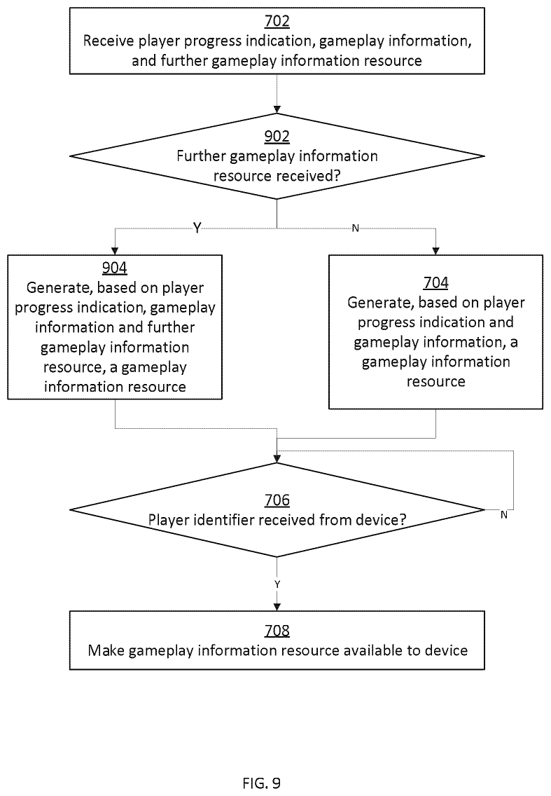

FIG. 9 shows an example method of generating a gameplay information resource in dependence on an additional gameplay information resource associated with another player. In this method, in addition to steps 702, 704, 706 and 708 of FIG. 7: a further gameplay information resource associated with a further player identifier identifying a further player may be received 902; and if the further gameplay information resource is received, the method includes generating 904 the gameplay information resource in dependence on the further gameplay information resource.

Note that the methods in FIGS. 8 and 9 can, in some examples, be combined.

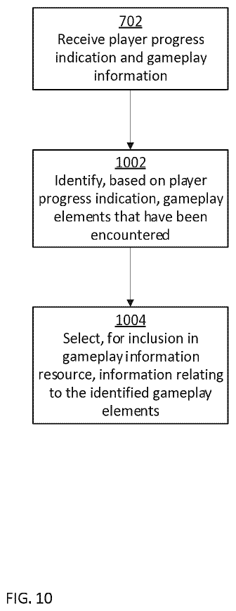

FIG. 10 shows an example method for determining which parts of the gameplay information to include in a gameplay information resource. In the method of FIG. 10, in addition to step 702 from FIG. 7: 1002: based on the player progress indicator, one or more gameplay elements that have been encountered by the player are identified (e.g. this step may be performed by the processing circuitry); 1004: the gameplay information resource is generated (e.g. by the processing circuitry) to include, as the subset, information relating to the one or more gameplay elements that have been encountered by the player.

The method of FIG. 10 could be used in combination with any of the other methods presented in FIGS. 7 to 9.

Moreover, any of the methods described above could be performed by a computer, under the control of a set of instructions contained within a computer program. Such a computer program could be stored on a computer-readable storage medium, which could be a transitory medium or a non-transitory medium.

1. An apparatus comprising:
communication circuitry to receive a progress indicator indicative of a player's progress in a game, and to receive gameplay information comprising supplementary information related to content of the game; and
processing circuitry to generate, based on the player progress indicator and the received gameplay information, a gameplay information resource associated with the player, wherein:
the communication circuitry is configured to receive, from a device, a player identifier identifying the player, and is responsive to receiving the player identifier to make the generated gameplay information resource accessible to the device; and
the communication circuitry is configured to receive a share request associated with the player identifier, the share request comprising a further player identifier identifying a further player, and is responsive to receiving the share request to make the generated gameplay information resource accessible to a further device associated with the further player identifier.

2. The apparatus of claim 1, wherein:
the communication circuitry is configured to receive the gameplay information from gameplay information storage circuitry; and
the gameplay information resource comprises a subset of the gameplay information stored by the gameplay information storage circuitry, wherein the subset is selected in dependence on the player progress indicator.

3. The apparatus of claim 2, wherein:
the processing circuitry is configured to identify, based on the player progress indicator, one or more gameplay elements that have been encountered by the player; and
the processing circuitry is configured to generate the gameplay information resource to include, as the subset, information relating to the one or more gameplay elements that have been encountered by the player.

4. The apparatus of claim 1, wherein:
the communication circuitry is configured to receive an additional gameplay information resource associated with an additional player identifier identifying an additional player; and
the processing circuitry is configured to generate the gameplay information resource in dependence on the additional gameplay information resource.

5. The apparatus of claim 1, wherein the communication circuitry is configured to send, to gameplay information storage circuitry, a request for the gameplay information, the request being sent in response to receiving at least one of:
a gameplay information resource request;
the player progress indication; and
an indication that the game has been added to the player's game library.

6. The apparatus of claim 1, wherein the gameplay information comprises at least one of:
text describing one or more in-game elements;
video data describing one or more in-game elements; and
audio data describing one or more in-game elements.

7. The apparatus of claim 6, wherein the one or more in-game elements comprise at least one of:
one or more in-game characters;
one or more in-game locations;
one or more in-game storylines;
in-game lore; and
one or more in-game user controls.

8. The apparatus of claim 1, wherein:
the communication circuitry is configured to receive the gameplay information from gameplay information storage circuitry; and
the gameplay information storage circuitry comprises a shared gameplay information resource.

9. The apparatus of claim 8, wherein the gameplay information comprises information downloaded from an online resource.

10. The apparatus of claim 1, comprising:
gameplay information storage circuitry to store the gameplay information,
wherein the communication circuitry is configured to receive the gameplay information from the gameplay information storage circuitry.

11. A method comprising:
receiving a progress indicator indicative of a player's progress in a game;
receiving gameplay information comprising supplementary information related to content of the game;
generating, based on the player progress indicator and the received gameplay information, a gameplay information resource associated with the player;
receiving, from a device, a player identifier identifying the player;
in response to receiving the player identifier, making the generated gameplay information resource accessible to the device;
receiving a share request associated with the player identifier, the share request comprising a further player identifier identifying a further player; and
in response to receiving the share request, making the generated gameplay information resource accessible to a further device associated with the further player identifier.

12. A non-transitory computer-readable storage medium storing a computer program comprising instructions which, when executed by a computer, cause the computer to perform a method comprising:
receiving a progress indicator indicative of a player's progress in a game;
receiving gameplay information comprising supplementary information related to content of the game;
generating, based on the player progress indicator and the received gameplay information, a gameplay information resource associated with the player;
receiving, from a device, a player identifier identifying the player;
in response to receiving the player identifier, making the generated gameplay information resource accessible to the device;
receiving a share request associated with the player identifier, the share request comprising a further player identifier identifying a further player, and
in response to receiving the share request, making the generated gameplay information resource accessible to a further device associated with the further player identifier.
